(19) United States
(12) Patent Application Publication
(10) Pub. No.: US 2026/0018091 A1
(43) Pub. Date: Jan. 15, 2026

(54) METHOD OF EVALUATING DISPLAY DRIVING ELEMENTS, AND DISPLAY PANEL

(71) Applicant: Samsung Display Co., LTD., Yongin-si (KR)

(72) Inventors: Eok Su KIM, Yongin-si (KR); Soyoung KOO, Yongin-si (KR); Jongdo KEUM, Yongin-si (KR); Hyungjun KIM, Yongin-si (KR); Geunchul PARK, Yongin-si (KR); Aeran SONG, Yongin-si (KR)

(21) Appl. No.: 19/095,849

(22) Filed: Mar. 31, 2025

(30) Foreign Application Priority Data
Jul. 15, 2024 (KR) 10-2024-0093267

(51) Int. Cl. G09G 3/00

(52) U.S. Cl. CPC G09G 3/006; G09G 2330/12

(57) ABSTRACT

A method of evaluating a display driving element includes controlling a transistor to be turned off, where the transistor is connected to a first end of a target driving transistor of a test element group (TEG) disposed in a non-display area of a display panel, and measuring characteristics of the target driving transistor through pads connected to respective terminals of the target driving transistor.

This application claims to Korean Patent Application No. 10-2024-0093267, filed on Jul. 15, 2024, and all the benefits accruing therefrom priority under 35 U.S.C. § 119, the content of which in its entirety is herein incorporated by reference.

### BACKGROUND

### 1. Field

Embodiments of the disclosure relate to a method of evaluating a display driving element, and a display panel.

### 2. Description of the Related Art

Pixel driving circuits respectively included in a plurality of pixels in a display panel may control a light-emitting device connected to each pixel driving circuit, to emit light based on a received signal. Signals applied to the pixel driving circuit may affect the brightness and timing of light-emitting devices that emit light by the pixel driving circuit.

The brightness of a light-emitting device is determined by a driving current applied to the light-emitting device, and the driving current may be generated by a driving transistor among various elements included in the pixel driving circuit. Thus, it may be desired to accurately obtain the characteristics of the driving transistor, and evaluation of a display panel and a display driving element may be performed based on the characteristics of the driving transistor.

### SUMMARY

To perform an inspection on a display panel that is manufactured, a test element group (TEG) may be set to verify the performance of the display panel by measuring physical and electrical characteristics of the display panel.

Embodiments of the disclosure provide a method of accurately evaluating a display driving element by blocking leakage current, and a display panel.

According to an embodiment of the disclosure, a method of evaluating a display driving element includes controlling a transistor to be turned off, where the transistor is connected to a first end of a target driving transistor of a test element group (TEG) disposed in a non-display area of a display panel, and measuring characteristics of the target driving transistor through pads connected to respective terminals of the target driving transistor.

In an embodiment, the TEG may have a same structure as a structure of a pixel driving circuit disposed in a display area of the display panel.

In an embodiment, a gate terminal of the transistor connected to the first end of the target driving transistor may be connected to an additional pad, and the controlling of the transistor to be turned off may include applying an off voltage through the additional pad connected to the gate terminal of the transistor connected to the first end of the target driving transistor.

In an embodiment, the additional pad may be further connected to a gate terminal of one or more transistors connected to a first end of each of one or more driving transistors other than the target driving transistor.

In an embodiment, the measuring the characteristics of the target driving transistor may include changing a gate voltage of the target driving transistor and measuring a driving current flowing through the target driving transistor.

In an embodiment, the first end of the target driving transistor may include a source terminal of the target driving transistor, and the source terminal of the target driving transistor may be connected to a source terminal of the transistor connected to the first end of the target driving transistor.

In an embodiment, the transistor connected to the first end of the target driving transistor may be turned on by a sensing signal and may transmit a signal to initialize a light-emitting device.

According to another embodiment of the disclosure, a display panel includes a display area in which a plurality of pixel driving circuits is disposed, and a non-display area in which a TEG having a same structure as a structure of the pixel driving circuits is disposed, where the TEG includes a driving transistor having terminals respectively connected to pads, and a first transistor connected to a first end of the driving transistor and having a gate terminal connected to an additional pad.

In an embodiment, the first transistor may be controlled to be turned off, and characteristics of the driving transistor may be measured through pads connected to the respective terminals of the driving transistor.

In the embodiment, the first transistor may be controlled to be turn off by an off voltage that is applied through the additional pad connected to the gate terminal of the first transistor.

In an embodiment, the characteristics of the driving transistor may be measured by changing a gate voltage of the driving transistor and measuring a driving current flowing through the driving transistor.

In the embodiment, the first end of the driving transistor may include a source terminal of the driving transistor, and the source terminal of the driving transistor may be connected to a source terminal of the first transistor.

In an embodiment, the TEG may further include a second transistor, and a source terminal of the first transistor may be connected to a source terminal of the driving transistor, and a source terminal of the second transistor may be connected to a gate terminal of the driving transistor.

In an embodiment, the first transistor may be turned on by a sensing signal to transmit a signal to initialize a light-emitting device, and the second transistor may be turned on by a scan signal to transmit a data signal.

In an embodiment, the first transistor may be turned on by an integrated scan/sensing signal to transmit a signal to initialize a light-emitting device, and the second transistor may be turned on by the integrated scan/sensing signal to transmit a data signal.

Other features of embodiments of the disclosure in addition to those described above will become apparent from the following drawings, claims and detailed description of the disclosure.

Embodiments of the disclosure may be practiced using any system, method, computer program, or combination of any system, method, or computer program.

### BRIEF DESCRIPTION OF THE DRAWINGS

The above and other features of certain embodiments of the disclosure will be more apparent from the following description taken in conjunction with the accompanying drawings, in which:

FIG. 1 is a plan view schematically illustrating a display panel according to an embodiment;

FIG. 2 is a circuit diagram for describing a structure of a pixel driving circuit according to an embodiment;

FIG. 3 is a circuit diagram for describing a circuit structure of a test element group (TEG) according to an embodiment of the disclosure;

FIG. 4 is a circuit diagram for describing a structure of a pixel driving circuit according to another embodiment;

FIG. 5 is a circuit diagram for describing a circuit structure of a TEG according to another embodiment of the disclosure;

FIG. 6 is a flowchart of a method of evaluating a display driving element, according to an embodiment of the disclosure;

FIG. 7 is a detailed flowchart illustrating an operation of controlling a transistor to be turned off, the transistor connected to a first end of a target driving transistor, according to an embodiment of the disclosure;

FIG. 8 is a detailed flowchart illustrating an operation of measuring characteristics of a driving transistor through pads connected to respective terminals of a target driving transistor, according to an embodiment of the disclosure; and

FIG. 9 is a block diagram of an apparatus for evaluating a display driving element, according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

In the following embodiments, terms such as “connect” or “combine” do not necessarily mean a direct and/or fixed connection or combination of two members, unless the context clearly indicates otherwise, and do not exclude that another member is interposed between the two members.

Also, in the drawings, for convenience of description, sizes of elements may be exaggerated or contracted. For example, the size and/or thickness of each component illustrated in the drawings are arbitrarily shown for convenience of explanation, and the disclosure is not necessarily limited to what is shown.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in detail with reference to the accompanying drawings, and in the description with reference to the drawings, like reference numerals refer to like elements and any repetitive detailed descriptions thereof will be omitted or simplified.

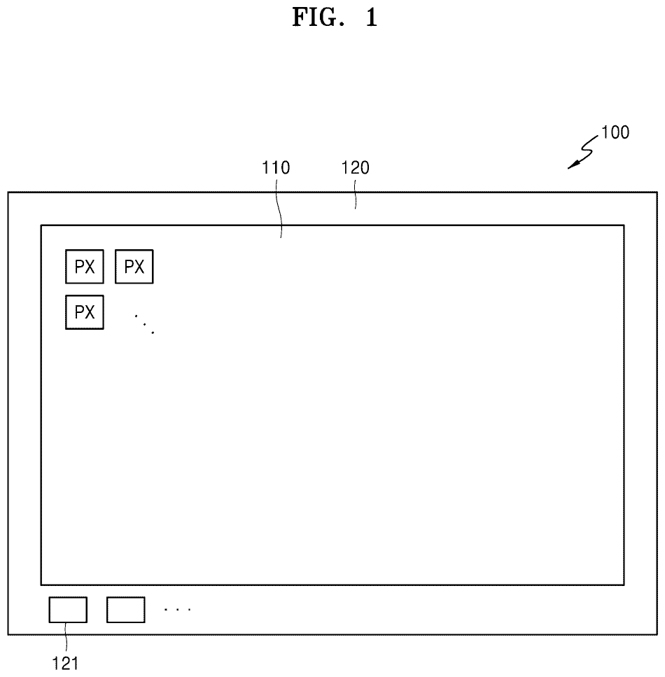

FIG. 1 is a plan view schematically illustrating a display panel according to an embodiment.

Referring to FIG. 1, an embodiment of a display panel 100 may include a display area 110 that displays an image, and a non-display area 120 which is around the display area 110 and in which elements and/or signal lines for generating and/or transmitting various signals to be applied to the display area 110 are arranged. The display area 110 may correspond to a screen of a display device including the display panel 100.

In an embodiment, the display area 110 of the display panel 100 may include a pixel portion which includes one or more pixels PX arranged in a matrix form, for example. The pixels PX may be implemented as a light-emitting device such as a light-emitting diode. Signal lines (not shown) such as data lines, scan lines, driving voltage lines, and sensing lines may also be disposed in the display area 110. A scan line and a data line are connected to each pixel PX, and a scan signal (also referred to as a gate signal) and a data signal (also referred to as a data voltage) may be received from these signal lines. In the display area 110, driving voltage lines configured to transmit a driving voltage ELVDD to the pixels PX may be disposed, and initialization voltage lines configured to transmit an initialization voltage Vinit to the pixels PX may be disposed. The scan lines, the data lines, the sensing lines, the driving voltage lines, and the initialization voltage lines may each extend in a first direction (left-right direction in FIG. 1) and/or a second direction (up-down direction in FIG. 1).

Each of the pixels PX or each of sub-pixels SPXn (n is a positive integer) of the display area 110 of the display panel 100 may include a pixel driving circuit. Each of the pixels PX or each of the sub-pixels SPXn may receive signals from the lines described above. A pixel driving circuit may include a transistor and a capacitor. The pixel driving circuit according to an embodiment of the disclosure will be described in detail later.

Although not illustrated in FIG. 1, driving portions (e.g., driving circuits) that generate and/or process various signals for driving the display panel 100 may be disposed in the non-display area 120 of the display panel 100. The driving portions may include a data driving portion that applies a data signal to the data line, a scan driving portion that applies a scan signal to the scan line, and a signal control portion that controls the data driving portion and the scan driving portion.

The scan driving portion may be integrated as a driving circuit in the non-display area 120 of the display panel 100. The data driving portion and the signal control portion may be formed as or defined by a single chip or as separate chips.

The non-display area 120 may include one or more test element groups (TEGs) 121. In an embodiment, a TEG 121 may be located, for example, in the non-display area 120 at a lower left or lower right portion of the display panel 100. The TEG 121 may include an inspection circuit for inspecting the characteristics and reliability of elements located in the display area 110 (e.g., transistors). The TEG 121 may have a same structure as a structure of the pixel driving circuit of each of the pixels PX disposed in the display area 110.

Since the TEG 121 has the same structure as that of the pixel driving circuit of the pixel PX of the display area 110, a display driving element may be evaluated through the TEG 121. In an embodiment, for example, a display driving element may be evaluated by measuring, through the TEG 121, the characteristics of a driving transistor of a pixel driving circuit.

In an embodiment, although not shown in FIG. 1, the display panel 100 may further include other elements, circuits, and components for driving the display panel 100 or a display device including the display panel 100.

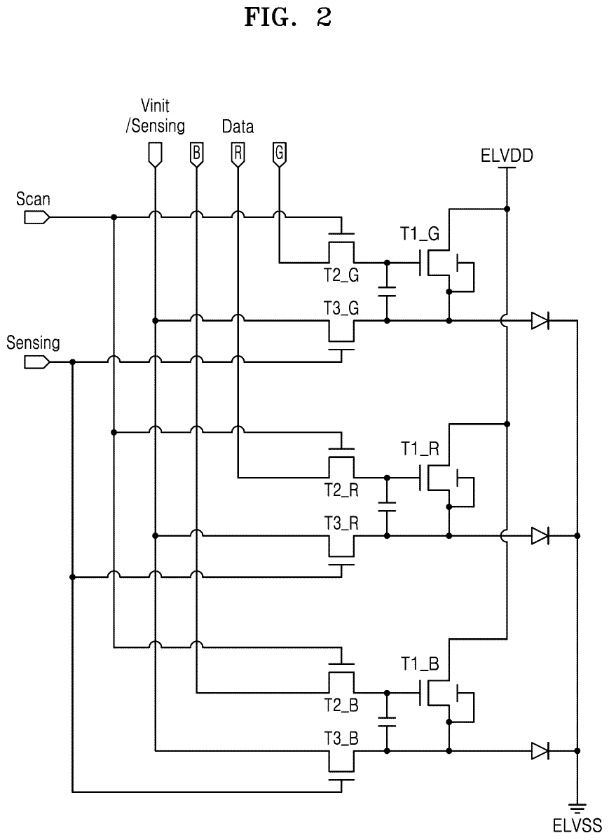

FIG. 2 is a circuit diagram for describing a structure of a pixel driving circuit according to an embodiment.

The pixel driving circuit illustrated in FIG. 2 may be understood as including a plurality of sub-pixel driving circuits, and the plurality of sub-pixel driving circuits illustrated in FIG. 2 may be designed to emit green, red, and blue light, respectively. Different elements may be included in each of the plurality of subpixel driving circuits according to a color of light to be emitted.

Referring to FIG. 2, in addition to a light-emitting device, a subpixel driving circuit may include three transistors T1, T2, T3; for example, a subpixel driving circuit corresponding to emission of green light may include three transistors T1_G, T2_G, and T3_G and one storage capacitor.

The light-emitting device may emit light corresponding to a current supplied through the first transistor T1. The light-emitting device may include a first end, a second end, and at least one emission layer disposed therebetween. The emission layer may emit light in a specific wavelength range by electrical signals transmitted from the first end and the second end.

The first end of the light-emitting device may be connected to a source terminal of the first transistor T1, and the second end thereof may be connected to a second power voltage ELVSS (or a common voltage or a low potential voltage) that is lower than a first power voltage ELVDD (or a driving voltage or a high potential voltage). Additionally, the first end of the light-emitting device may be connected to a source terminal of the third transistor T3.

The first transistor T1 may be referred to as a driving transistor. The first transistor T1 may adjust a current flowing from the first power voltage to the light-emitting device according to a voltage difference between a gate terminal and the source terminal of the first transistor T1. The gate terminal of the first transistor T1 may be connected to a source terminal of the second transistor T2, the source terminal of the first transistor T1 may be connected to the first end of the light-emitting device, and a drain terminal of the first transistor T1 may be connected to the first power voltage ELVDD.

The second transistor T2 may be turned on by a scan signal of a scan line to connect a data line to the gate terminal of the first transistor T1. A gate terminal of the second transistor T2 may be connected to the scan line, a source terminal of the second transistor T2 may be connected to the gate terminal of the first transistor T1, and a drain terminal of the second transistor T2 may be connected to the data line.

The third transistor T3 may be turned on by a sensing signal from a sensing line to connect an initialization voltage line to the first end of the light-emitting device. A gate terminal of the third transistor T3 may be connected to the sensing line, and a source terminal of the third transistor T3 may be connected to the first end of the light-emitting device or the source terminal of the first transistor T1.

In an embodiment, the source terminal and the drain terminal of each of the first, second, and third transistors T1, T2, and T3 are not limited to those described above, and may be arranged interchangeably. In FIG. 2, an embodiment where the first, second, and third transistors T1, T2, and T3, each provided as an N-type metal oxide semiconductor field effect transistor (MOSFET) is shown as an example, but the disclosure is not limited thereto. In another embodiment, the first, second, and third transistors T1, T2, and T3 may be each formed as a P-type MOSFET, or some of the first, second, and third transistors T1, T2, and T3 may be formed as an N-type MOSFET, and others may be formed as a P-type MOSFET.

A storage capacitor may be connected or formed between the gate terminal and the source terminal of the first transistor T1. The storage capacitor may store a voltage difference between a gate voltage and a source voltage of the first transistor T1.

The pixel driving circuit illustrated in FIG. 2 may be included in a pixel PX disposed in the display area 110 of the display panel 100, but as described above, the TEG 121 may have the same structure as that of the pixel driving circuit of the pixel PX disposed in the display area 110, and thus, the TEG 121 disposed in the non-display area 120 of the display panel 100 may also be configured as the pixel driving circuit illustrated in FIG. 2.

In such an embodiment, as described above, a display driving element may be evaluated through the TEG 121. Since the first transistor T1, which is a driving transistor, is directly related to a current flowing to the light-emitting device, characteristics of the first transistor T1 may be the major characteristic of the display driving element. Thus, by increasing a gate voltage (e.g., a gate-source voltage (V_{GS})) of the first transistor T1 and measuring a current (e.g., a drain-source current (I_{DS})) flowing through the first transistor T1 to the light-emitting device, and obtaining a transfer curve of the first transistor T1, the characteristics of the first transistor T1 may be measured.

When evaluating the characteristics of the first transistor T1 based on the pixel driving circuit illustrated in FIG. 2, gate terminals of other transistors may be floating, and accordingly, a leakage current may occur. A leakage current may cause a hump on the transfer curve, which may lead to incorrect measurement of the characteristics of the first transistor T1.

For example, to measure the characteristics of the first transistor T1_G corresponding to emission of green light in FIG. 2, that is, when the first transistor T1_G corresponding to emission of green light is a target driving transistor, gate terminals of a first transistor T1_R corresponding to emission of red light, a first transistor T1_B corresponding to emission of blue light, and third transistors T3_G, T3_R, and T3_B corresponding to emission of green, red, and blue light, respectively may be floated. Accordingly, transistors other than the target driving transistor may not be completely turned off, which may cause a leakage current.

In an embodiment, to obtain an accurate transfer curve of the target driving transistor by effectively preventing the leakage current from occurring, an embodiment of a method of evaluating a display driving element, according to the disclosure, may be performed.

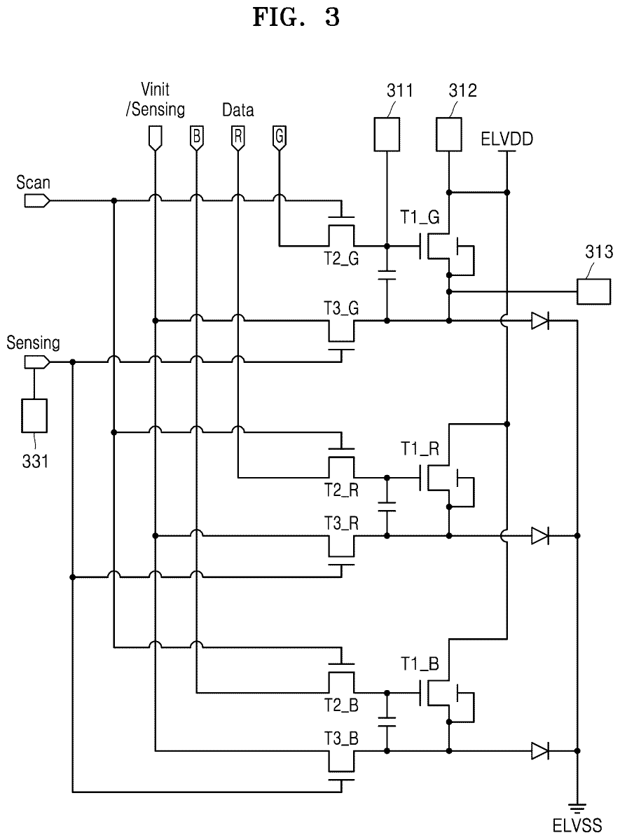

FIG. 3 is a circuit diagram for describing a circuit structure of a TEG according to an embodiment of the disclosure.

A circuit illustrated in FIG. 3 may be configured based on the pixel driving circuit described with reference to FIG. 2.

Similar to the pixel driving circuit illustrated in FIG. 2, a circuit of the TEG 121 according to an embodiment of the disclosure illustrated in FIG. 3 may be understood as including a plurality of sub-circuits, and the plurality of sub-circuits may each include a circuit that is identical to a subpixel driving circuit designed to emit green, red, or blue light.

Referring to FIG. 3, in addition to a light-emitting device, the sub-circuit may include three transistors T1, T2, T3; for example, a sub-circuit corresponding to emission of green light may include three transistors T1_G, T2_G, and T3_G, and one storage capacitor.

For the description of the operation of each component and the detailed circuit, the details described above with reference to FIG. 2 may be similarly applied.

A circuit of the TEG 121 according to an embodiment of the disclosure may further include one or more pads. An electrical signal (e.g., a voltage or current) may be applied or output through the one or more pads.

In an embodiment, the circuit of the TEG 121 may further include pads respectively connected to terminals of a driving transistor. When the first transistor T1_G corresponding to emission of green light is a target driving transistor, that is, in the example illustrated in FIG. 3, the circuit of the TEG 121 may further include pads 311, 312, and 313 respectively connected to terminals of the target driving transistor. The pad 311 may be connected to a gate terminal of the target driving transistor, the pad 312 may be connected to a drain terminal of the target driving transistor, and the pad 313 may be connected to a source terminal of the target driving transistor.

In an embodiment, the pads 311, 312, and 313 respectively connected to the terminals of the target driving transistor may be used to measure the characteristics of the target driving transistor. A voltage may be applied to the respective terminals of the target driving transistor through the pads 311, 312, and 313 respectively connected to the terminals of the target driving transistor, or a current flowing through each terminal may be measured. In an embodiment, for example, by increasing a gate voltage applied to the target driving transistor through the pad 311, the gate-source voltage (V_{GS}) of the target driving transistor may be increased, and by measuring, through the pad 312 and the pad 313, the drain-source current (I_{DS}), which is a current flowing to the light-emitting device through the target driving transistor, a transfer curve of the target driving transistor may be obtained.

In an embodiment, the circuit of the TEG 121 may further include a pad connected to a gate terminal of a transistor connected to one of the terminals of the driving transistor. In an embodiment, the circuit of the TEG 121 may further include a pad connected to a gate terminal of the third transistor T3 connected to a source terminal of a driving transistor, for example, the third transistor T3_G, the third transistor T3_R, and/or the third transistor T3_B.

In an embodiment, a pad connected to the gate terminal of the third transistor T3 may be used to control the third transistor T3 to be turned off. That is, an off voltage (V_{off}), which is a voltage for turning off the third transistor T3, may be applied through the pad connected to the gate terminal of the third transistor T3. For example, the off voltage (V_{off}) may be about −5 volts (V), but may differ depending on the specifications and type of the third transistor T3.

In an embodiment, as shown in FIG. 3, the circuit of the TEG 121 may further include an additional pad 331. Referring to FIG. 3, the additional pad 331 may be connected to a sensing line. When an off voltage (V_{off}) is applied through the additional pad 331, the off voltage (V_{off}) is applied to the third transistor T3_G, the third transistor T3_R, and the third transistor T3_B, such that the third transistor T3_G, the third transistor T3_R, and the third transistor T3_B may be turned off.

In an embodiment, when the third transistor T3_G, the third transistor T3_R, and the third transistor T3_B are turned off by applying an off voltage (V_{off}) through the additional pad 331, a leakage current causing a hump on the transfer curve may be effectively blocked, thereby allowing to obtain an accurate transfer curve of the target driving transistor.

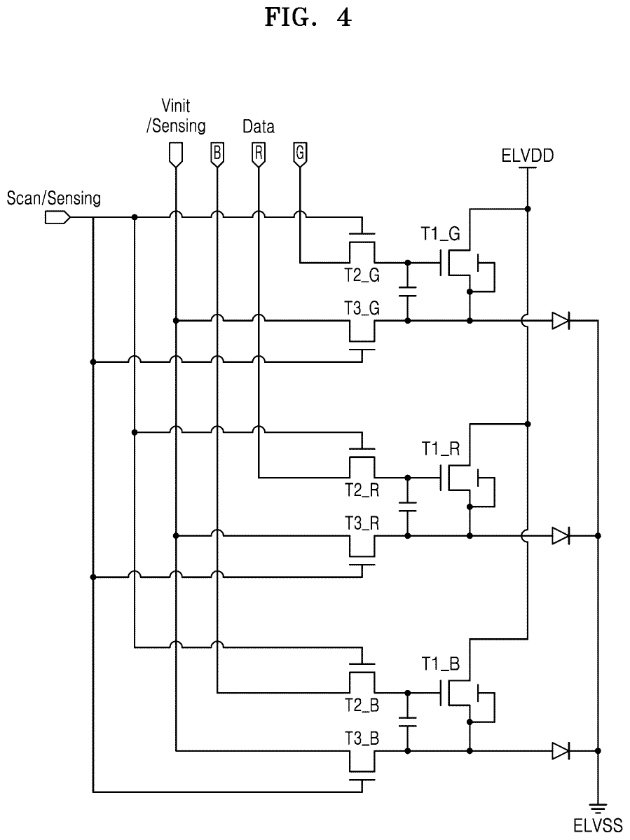

FIG. 4 is a circuit diagram for describing a structure of a pixel driving circuit according to another embodiment.

The pixel driving circuit illustrated in FIG. 4 may be understood as including a plurality of sub-pixel driving circuits, and the plurality of sub-pixel driving circuits illustrated in FIG. 4 may be designed to emit green, red, and blue light, respectively. Different elements may be included in each of the plurality of subpixel driving circuits according to a color of light to be emitted.

The pixel driving circuit illustrated in FIG. 4 is substantially the same as the pixel driving circuit illustrated in FIG. 2 except that a scan signal and a sensing signal are applied in an integrated manner. Referring to FIG. 4, in an embodiment, an integrated scan/sensing signal may be applied to second transistors T2_G, T2_R, T2_B and third transistors T3_G, T3_R, T3_B.

Thus, the second transistor T2 may be turned on by the integrated scan/sensing signal of the scan/sensing line to connect the data line to the gate terminal of the first transistor T1, and the third transistor T3 may be turned on by the integrated scan/sensing signal of the scan/sensing line to connect an initialization voltage line to the first end of the light-emitting device.

In regard to the operations of the other components of the pixel driving circuit illustrated in FIG. 4 and the detailed description of the circuit, the details described above with reference to FIG. 2 may be similarly applied.

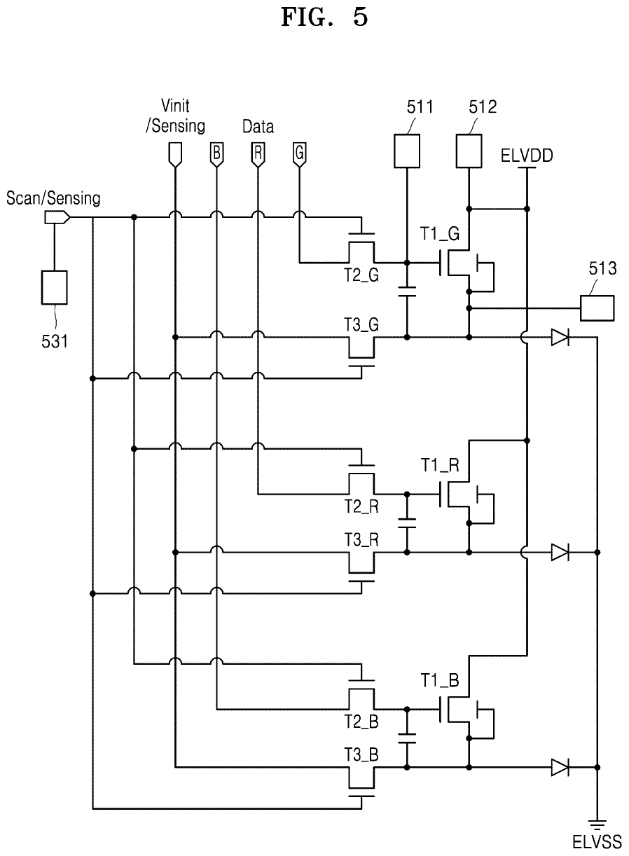

FIG. 5 is a circuit diagram for describing a circuit structure of a TEG according to another embodiment of the disclosure.

A circuit illustrated in FIG. 5 may be configured based on the pixel driving circuit described with reference to FIG. 4.

Similar to the pixel driving circuit illustrated in FIG. 4, a circuit of the TEG 121 according to an embodiment of the disclosure may be understood as including a plurality of sub-circuits, and the plurality of sub-circuits may each include a circuit that is identical to subpixel driving circuits designed to emit green, red, and blue light, respectively.

Referring to FIG. 5, in addition to a light-emitting device, the sub-circuit may include three transistors T1, T2, T3; for example, a sub-circuit corresponding to emission of green light may include three transistors T1_G, T2_G, and T3_G and one storage capacitor.

In regard to the description of the operation of each component and the detailed circuit, the details described above reference to FIG. 2 or FIG. 4 may be similarly applied.

The circuit of the TEG 121 according to an embodiment of the disclosure may further include one or more pads.

In an embodiment, the circuit of the TEG 121 may further include pads respectively connected to terminals of a driving transistor. When the first transistor T1_G corresponding to emission of green light is a target driving transistor, that is, in the example illustrated in FIG. 5, the circuit of the TEG 121 may further include pads 511, 512, and 513 respectively connected to the terminals of the target driving transistor. The pad 511 may be connected to a gate terminal of the target driving transistor, the pad 512 may be connected to a drain terminal of the target driving transistor, and the pad 513 may be connected to a source terminal of the target driving transistor.

In an embodiment, the pads 511, 512, and 513 respectively connected to the terminals of the target driving transistor may be used to measure the characteristics of the target driving transistor. A voltage may be applied to the respective terminals of the target driving transistor through the pads 511, 512, and 513 respectively connected to the terminals of the target driving transistor, or a current flowing through each terminal may be measured. In an embodiment, for example, by increasing a gate voltage applied to the target driving transistor through the pad 511, the gate-source voltage (V_{GS}) of the target driving transistor may be increased, and by measuring, through the pad 512 and the pad 513, the drain-source current (I_{DS}), which is a current flowing to the light-emitting device through the target driving transistor, a transfer curve of the target driving transistor may be obtained.

In an embodiment, the circuit of the TEG 121 may further include a pad connected to a gate terminal of a transistor connected to one of the terminals of the driving transistor. The circuit of the TEG 121 according to an embodiment of the disclosure may further include an additional pad connected to the second transistor T2 connected to a gate terminal of a driving transistor, for example, a gate terminal of the second transistor T2_G, a second transistor T2_R, and/or a second transistor T2_B, and/or a gate terminal of the third transistor T3 connected to a source terminal of a driving transistor, for example, the third transistor T3_G, a third transistor T3_R, and/or a third transistor T3_B.

In an embodiment, an additional pad connected to the gate terminal of the second transistor T2 and/or the third transistor T3 may be used to control the second transistor T2 and/or the third transistor T3 to be turned off. That is, a voltage for turning off the second transistor T2 and/or the third transistor T3 through the additional pad connected to the gate terminal of the second transistor T2 and/or the third transistor T3, an off voltage (V_{off}) may be applied.

In an embodiment, as shown in FIG. 5, the circuit of the TEG 121 may further include an additional pad 531. Referring to FIG. 5, the additional pad 531 may be connected to a scan/sensing line. When an off voltage (V_{off}) is applied through the additional pad 531, the off voltage (V_{off}) is applied to the second transistor T2_G, the second transistor T2_R, the second transistor T2_B, the third transistor T3_G, the third transistor T3_R, and the third transistor T3_B, such that the second transistor T2_G, the second transistor T2_R, the second transistor T2_B, the third transistor T3_G, the third transistor T3_R, and the third transistor T3_B may be turned off.

In an embodiment, when an off voltage (V_{off}) is applied through the additional pad 531, the second transistor T2_G, the second transistor T2_R, the second transistor T2_B, the third transistor T3_G, and the third transistor T3_R, and the third transistor T3_B are turned off, such that a leakage current that causes a hump on a transfer curve may be blocked, thus allowing to obtain an accurate transfer curve of the target driving transistor.

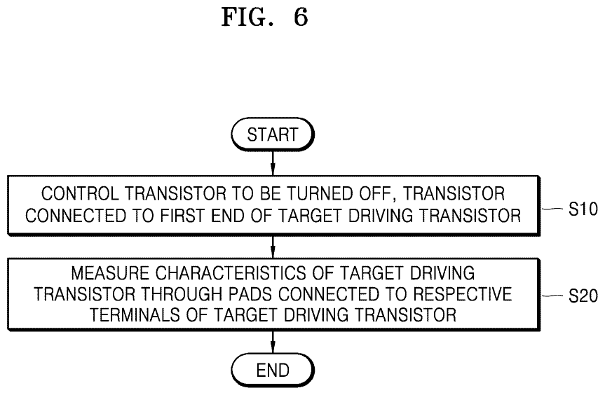

FIG. 6 is a flowchart of a method of evaluating a display driving element, according to an embodiment of the disclosure.

Since the method of evaluating a display driving element, illustrated in FIG. 6, relates to the embodiments described above, any repetitive detailed description of the same or like elements as those described above will hereinafter be omitted or simplified.

An embodiment of the method of evaluating a display driving element, illustrated in FIG. 6, may be a method of evaluating a display driving element by using an embodiment of the TEG 121 described above.

An embodiment of the method of evaluating a display driving element, illustrated in FIG. 6, may be performed by an apparatus for evaluating a display driving element, particularly, a processor included in the apparatus for evaluating a display driving element.

The apparatus for evaluating a display driving element, according to an embodiment of the disclosure, may perform a method of evaluating a display driving element by controlling pads of a circuit of the TEG 121 according to an embodiment of the disclosure.

Referring to FIG. 6, an embodiment of the method of evaluating a display driving element may include controlling a transistor to be turned off, where the transistor is connected to a first end of a target driving transistor (S10).

As described above, here, the target driving transistor may refer to a driving transistor, characteristics of which are to be measured among driving transistors included in the TEG 121 disposed in the non-display area 120.

In an embodiment, the transistor connected to the first end of the target driving transistor may be a second transistor and/or a third transistor.

Referring to FIG. 6, an embodiment of the method of evaluating a display driving element may include measuring the characteristics of the target driving transistor through pads connected to respective terminals of the target driving transistor (S20).

As described above, the TEG 121 may include a pad connected to the gate terminal of the target driving transistor, a pad connected to the drain terminal of the target driving transistor, and a pad connected to the source terminal of the target driving transistor, and the characteristics of the target driving transistor may be measured through the pads.

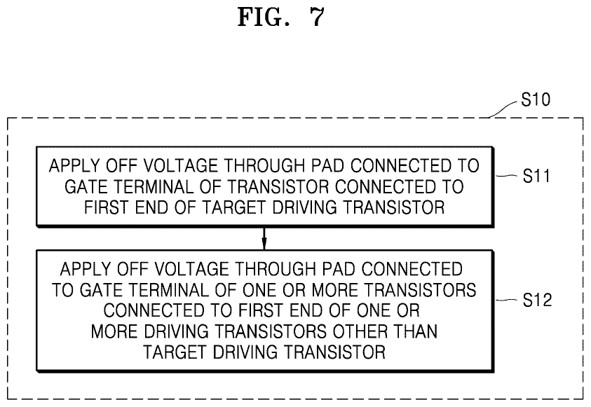

FIG. 7 is a detailed flowchart illustrating an operation of controlling a transistor to be turned off, where the transistor is connected to a first end of a target driving transistor, according to an embodiment of the disclosure.

Referring to FIG. 7, in an embodiment, an operation of controlling the transistor connected to the first end of the target driving transistor the transistor to be turned off (S10) may include an operation of applying an off voltage through the pad connected to a gate terminal of the transistor connected to the first end of the target driving transistor (S11).

In an embodiment, for example, as shown in FIG. 3, where the first transistor T1_G is the target driving transistor, a transistor connected to the first end of the target driving transistor may be the third transistor T3_G.

Referring to FIG. 7, in an embodiment, the operation of controlling the transistor connected to the first end of the target driving transistor to be turned off (S10) may include an operation of applying an off voltage through a pad connected to a gate terminal of one or more transistors connected to a first end of one or more driving transistors other than the target driving transistor (S12).

In an embodiment, for example, as shown in FIG. 3, where the first transistor T1_G is a target driving transistor, the one or more driving transistors other than the target driving transistor may be a first transistor T1_R and a first transistor T1_B, and one or more transistors connected to a first end of each of the one or more driving transistors other than the target driving transistor may be a third transistor T3_R and a third transistor T3_B.

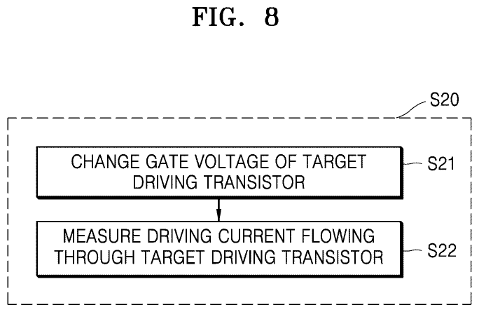

FIG. 8 is a detailed flowchart illustrating an operation of measuring characteristics of a driving transistor through pads connected to respective terminals of a target driving transistor, according to an embodiment of the disclosure.

Referring to FIG. 8, in an embodiment, the operation of measuring the characteristics of the target driving transistor through the pads connected to the respective terminals of the target driving transistor (S20) may include changing a gate voltage of the target driving transistor (S21).

In an embodiment, as described above, a voltage may be applied to each terminal of the target driving transistor through the pads connected to the respective terminals of the target driving transistor.

Referring to FIG. 8, in an embodiment, the operation of measuring the characteristics of the target driving transistor through the pads connected to the terminals of the target driving transistor (S20) may include an operation of measuring a driving current flowing through the target driving transistor (S22).

In an embodiment, as described above, a current flowing through each terminal of the target driving transistor may be measured through pads connected to the respective terminals.

Each operation of the method of evaluating a display driving element described above is described by way of example, and the method of evaluating a display driving element may be performed based on the various embodiments described above.

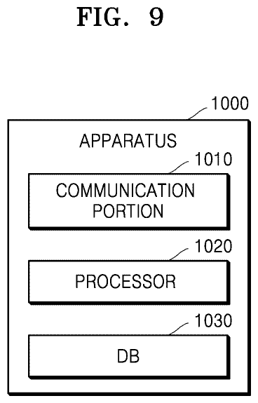

FIG. 9 is a block diagram of an apparatus for evaluating a display driving element, according to an embodiment of the disclosure.

Referring to FIG. 9, an embodiment of an apparatus 1000 for evaluating a display driving element may include a communication portion 1010, a processor 1020, and a database (DB) 1030. In FIG. 9, only components related to an embodiment of the apparatus 1000 for evaluating a display driving element are illustrated. Accordingly, it will be understood by those skilled in the art that other general-purpose components may be included in addition to the components illustrated in FIG. 9.

The communication portion 1010 may include one or more components that communicate with the display panel 100 or a display device including the display panel 100.

The DB 1030 is hardware that stores various data processed within the apparatus 1000 for evaluating a display driving element, and may store programs for processing and control of the processor 1020. The DB 1030 may include memory of any type and form.

The processor 1020 may control the overall operation of the apparatus 1000 for evaluating a display driving element. In an embodiment, for example, the processor 1020 may control at least some of operations of the apparatus 1000 for evaluating a display driving element by executing the programs stored in the DB 1030. In an embodiment, for example, the operation of the apparatus 1000 for evaluating a display driving element may include a method of evaluating a display driving element, described above. The processor 1020 may be implemented using a processor device of any type and form.

In an embodiment, an apparatus for evaluating a display driving element may be included in the display panel 100 or a display device including the display panel 100. In an embodiment, for example, the apparatus for evaluating a display driving element may be the same as or included in any one of driving portions that generate and/or process various signals for driving the display panel 100 described above.

In another embodiment, the apparatus for evaluating a display driving element includes an apparatus separately provided outside the display panel 100 or a display device including the display panel 100, and may be electrically connected to the display panel 100 or the display device including the display panel 100 and perform the method of evaluating a display driving element.

Each of the embodiments described above may be implemented independently, but the configuration of each embodiment may also be applied in combination with other embodiments.

As such, the disclosure has been described with reference to the embodiments illustrated in the drawings, but these are merely illustrative, and those skilled in the art will understand that various modifications and equivalent other embodiments may be made therefrom. Therefore, the scope of the disclosure should be determined by the technical spirit of the appended claims.

Specific implementations described with reference to the embodiments are examples and do not limit the scope of the embodiments in any way. Additionally, if there is no specific description such as “essential,” “important,” etc., it may not be a necessary component for the application of the disclosure.

In the specification of the embodiments (particularly in the claims), the use of the term “above” and similar referential terms may refer to both the singular and the plural. In addition, when a range is described in an example, the disclosure includes the application of individual values within the range (unless there is a statement to the contrary), and the range is the same as each individual value constituting the range in the detailed description. Finally, unless the order of the steps constituting the method according to the embodiments is clearly stated or there is no description to the contrary, the steps may be performed in an appropriate order. The embodiments are not necessarily limited by the order of description of the steps above. The use of all examples or illustrative terms in the embodiments is simply for describing the embodiments in detail, and the scope of the embodiments is not limited by the examples or illustrative terms unless limited by the claims. Additionally, those skilled in the art will recognize that various modifications, combinations and changes may be made according to design conditions and factors within the scope of the appended claims or their equivalents.

According to an embodiment of the disclosure, by blocking a path of leakage current, the characteristics of a driving transistor may be accurately measured.

In particular, a driving current in a low voltage region on a transfer curve, for example, a region in which a differential voltage between a gate terminal and a source terminal is less than 0, may be measured normally.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A method of evaluating a display driving element, the method comprising:
controlling a transistor to be turned off, wherein the transistor is connected to a first end of a target driving transistor of a test element group disposed in a non-display area of a display panel; and
measuring characteristics of the target driving transistor through pads connected to respective terminals of the target driving transistor.

2. The method of claim 1, wherein the test element group has a same structure as a structure of a pixel driving circuit disposed in a display area of the display panel.

3. The method of claim 1, wherein a gate terminal of the transistor connected to the first end of the target driving transistor is connected to a pad, and
the controlling the transistor to be turned comprises applying an off voltage through the pad connected to the gate terminal of the transistor connected to the first end of the target driving transistor.

4. The method of claim 3, wherein the pad is further connected to a gate terminal of one or more transistors connected to a first end of each of one or more driving transistors other than the target driving transistor.

5. The method of claim 1, wherein the measuring the characteristics of the target driving transistor comprises:
changing a gate voltage of the target driving transistor; and
measuring a driving current flowing through the target driving transistor.

6. The method of claim 1, wherein the first end of the target driving transistor comprises a source terminal of the target driving transistor, and
the source terminal of the target driving transistor is connected to a source terminal of the transistor connected to the first end of the target driving transistor.

7. The method of claim 1, wherein the transistor connected to the first end of the target driving transistor is turned on by a sensing signal and transmits a signal to initialize a light-emitting device.

8. A display panel comprising:
a display area in which a plurality of pixel driving circuits is disposed; and
a non-display area in which a test element group having a same structure as a structure of the pixel driving circuits is disposed,
wherein the test element groups comprises:
a driving transistor having terminals respectively connected to pads; and
a first transistor connected to a first end of the driving transistor and having a gate terminal connected to a pad.

9. The display panel of claim 8, wherein the first transistor is controlled to be turned off, and
characteristics of the driving transistor are measured through pads connected to the respective terminals of the driving transistor.

10. The display panel of claim 9, wherein the first transistor is controlled to be turn off by an off voltage applied through the pad connected to the gate terminal of the first transistor.

11. The display panel of claim 9, wherein the characteristics of the driving transistor are measured by changing a gate voltage of the driving transistor and measuring a driving current flowing through the driving transistor.

12. The display panel of claim 8, wherein the first end of the driving transistor comprises a source terminal of the driving transistor, and
the source terminal of the driving transistor is connected to a source terminal of the first transistor.

13. The display panel of claim 8, wherein the test element groups further comprises a second transistor, and
a source terminal of the first transistor is connected to a source terminal of the driving transistor, and
a source terminal of the second transistor is connected to a gate terminal of the driving transistor.

14. The display panel of claim 13, wherein the first transistor is turned on by a sensing signal to transmit a signal to initialize a light-emitting device, and
the second transistor is turned on by a scan signal to transmit a data signal.

15. The display panel of claim 13, wherein the first transistor is turned on by an integrated scan/sensing signal to transmit a signal to initialize a light-emitting device, and
the second transistor is turned on by the integrated scan/sensing signal to transmit a data signal.
